(19) United States
(12) Patent Application Publication
(10) Pub. No.: US 2003/0115978 A1
(43) Pub. Date: Jun. 26, 2003

(54) Apparatus and method for monitoring environment within a container

(76) Inventors: Stephanie J. Moehnke, Forest Grove, OR (US); James N.L. Pedersen, Sherwood, OR (US); Wayne C. Olson, Eden Prairie, MN (US); William J. Shaner, Colorado Springs, CO (US); Connie E. Barela, Colorado Springs, CO (US); Philip S. Glynn, Colorado Springs, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/026,386

(22) Filed: Dec. 20, 2001

(51) Int. Cl. G01M 19/00

(52) U.S. Cl. 73/866.5; 340/870.16

(57) ABSTRACT

An apparatus and method for recording the environmental conditions within a container during transportation or periods of extended storage, the container for receiving semiconductor wafers or other sensitive components.

### FIELD OF THE INVENTION

The invention relates generally to the transportation of semiconductor wafers and other sensitive components. In particular, the invention relates to an apparatus and method for sensing and recording environmental conditions within a container during transit and/or extended storage.

### BACKGROUND OF THE INVENTION

Integrated circuit devices are typically manufactured on a relatively large semiconductor wafer, and a single wafer will often include hundreds of such devices formed thereon. Once the integrated circuits have been formed on a semiconductor wafer and subjected to any necessary testing, the wafer is cut into a plurality of die—a die including one or more integrated circuits—and each die is subsequently packaged to create a packaged integrated circuit device or “chip.” Packaging may include the attachment of leads (e.g., a lead frame or a ball grid array) to the die and the encasement of the die in a potting material, as well as electrical testing and characterization. The fabrication of “raw” semiconductor wafers—i.e., wafers having no circuitry or other structures formed thereon—as well as the fabrication of integrated circuit devices are each performed in a highly controlled and monitored environment, and these environments are difficult to duplicate outside the fabrication facility.

Many integrated circuit (IC) manufacturers do not fabricate raw semiconductor wafers, and it is a common practice for IC manufacturers to receive raw wafers from outside vendors. Thus, the raw wafers must be shipped from the manufacturing facility to the IC manufacturer and, as noted above, it is difficult to duplicate the controlled fabrication environment outside the manufacturing facility. Further, it is often necessary to transport a “processed” semiconductor wafer—i.e., a wafer having a plurality of integrated circuits formed thereon—from the IC manufacturing facility to another location for cutting, packaging, and electrical characterization. In addition to transporting semiconductor wafers, it is sometimes necessary to store raw and processed wafers for extended periods of time at locations outside the controlled fabrication facility. Both raw and processed semiconductor wafers are transported and/or stored in shipping containers, such shipping containers being well known in the art.

Semiconductor wafers, whether in the raw or processed condition, are highly sensitive to their environment. For example, semiconductor wafers and any circuitry formed thereon are highly susceptible to chemical and particulate contamination, as well as to other environmental characteristics, such as temperature, humidity, and pressure. Severe vibration and shock may cause excessive stress in a wafer, as well as any circuitry formed on the wafer, resulting in fractures and damaged circuitry. Also, the build-up of an electrical charge on a semiconductor wafer and/or its shipping container—and the subsequent discharge of that electrical charge—may damage the wafer, especially the integrated circuits formed thereon. Further, electromagnetic radiation (both visible and non-visible) may damage a wafer and its circuitry. In some instances, two or more of these adverse environmental conditions may be present in combination, and their effects may be accumulative. By way of example, thermal-induced stresses may be present in combination with stresses due to excessive vibration and/or shock.

The shipping container used to transport semiconductor wafers or other sensitive components may itself be susceptible to adverse environmental conditions. For example, adverse environmental conditions (e.g., temperature, humidity, and/or pressure) within the shipping container may lead to outgassing from the shipping container—the shipping container typically being formed from a plastic material—and such outgassing may cause contamination of the contents (e.g., semiconductor wafers) stored within the shipping container. Further, shock and vibration imparted to the shipping container may cause relative movement between the container and its contents. Relative movement or rubbing between a shipping container and, for example, a semiconductor wafer may lead to particulate generation—the particulates emanating from the shipping container material as well as from the wafer material—and these particulates may contaminate the wafers stored within the shipping container.

If a semiconductor wafer is subjected to any of the above-described environmental conditions during transport, the resulting damage (e.g., micro-fractures, chemical contamination, particulate contamination) is often times not readily observable and difficult to detect. Further, such damage (or the effects of such damage) may not be realized until IC device fabrication is nearly complete (i.e., at the time of final electrical testing), resulting not only in the loss of damaged IC devices, but also in the resources devoted to processing damaged devices that will not yield marketable products. Thus, significant environmental damage can lead to low production yields and high production costs.

Other environmentally sensitive components may be transported and/or stored in shipping containers similar to those utilized for semiconductor wafers. By way of example, magnetically or optically accessible disks are often transported in similar shipping containers. Such magnetically and optically accessible disks are used in, for example, the construction of disk drives. Also, it may be desirable to transport flat panel displays—whether complete or in the partially fabricated condition—in some type of enclosed container.

One common solution to the above-described problem was to pull a “test wafer” from a group of wafers (i.e., the wafers stored in one shipping container) for testing. The test wafer was, after shipping or extended storage, analyzed for damage that may have resulted from the wafer being subjected to any undesirable environmental conditions. However, the analysis of the wafer often necessitated the destruction of the wafer, or at least a portion thereof, which required that the IC manufacturer sacrifice some product. Further, as previously noted, it is often difficult to detect the damage that a semiconductor wafer has incurred. Another solution often employed was to test a wafer in a simulated transportation and/or storage environment, such that the effects of certain environmental conditions could be quantified. However, a simulated environment may not accurately represent the actual shipping and/or storage conditions.

If an IC manufacturer had knowledge of the environmental conditions that a semiconductor wafer was subjected to during transportation, the IC manufacturer could assess the viability of the wafer. For a raw wafer, the manufacturer could avoid allocating production resources to a potentially damaged wafer that may exhibit a low production yield. Also, monitoring the environmental conditions of a processed semiconductor wafer during transport and/or extended storage may be used for quality assurance and to insure high yields without sacrificing useful product. Further, monitoring the environmental conditions within a shipping container may be useful for evaluating the design of the shipping container itself, as well as for evaluating the mode of transportation. Currently, however, IC manufacturers do not have the ability to track environmental conditions within a shipping container during transportation and/or extended storage of semiconductor wafers or other environmentally sensitive components.

### SUMMARY OF THE INVENTION

One embodiment comprises an instrumented substrate for use with a container, the container having an interior cavity for receiving a plurality of components. The instrumented substrate includes a substrate that can be inserted into the interior cavity of the container. The instrumented substrate further includes a monitoring system disposed on the substrate. The monitoring system can sense at least one environmental characteristic.

Another embodiment comprises a container. The container includes a housing having a housing wall that defines an interior cavity. The housing wall also includes an opening into the interior cavity. A plurality of shelves are disposed on the housing wall within the interior cavity, and each of the shelves can receive a component. A door is movably secured to the housing proximate the opening. The container further includes a monitoring system disposed on one of the housing wall and the door. The monitoring system can sense at least one environmental characteristic within the interior cavity.

### BRIEF DESCRIPTION OF THE DRAWINGS

FIG. 1 shows a perspective view of a conventional shipping container for transporting semiconductor wafers or other sensitive components.

FIG. 2 shows a perspective view of an embodiment of an instrumented substrate.

FIG. 3 shows a plan view of the instrumented substrate illustrated in FIG. 2.

FIG. 4 shows an elevation view of the instrumented substrate illustrated in FIG. 2.

FIG. 5 shows a schematic view of a monitoring system for the instrumented substrate of FIG. 2.

FIG. 6 shows an elevation view of the instrumented substrate of FIG. 2, as disposed in the conventional shipping container of FIG. 1.

FIG. 7 shows a perspective view of another embodiment of an instrumented substrate.

FIG. 8 shows a perspective view of a further embodiment of an instrumented substrate.

FIG. 9 shows a perspective view of yet another embodiment of an instrumented substrate.

FIG. 10 shows a perspective view of an embodiment of a shipping container having a monitoring system.

### DETAILED DESCRIPTION OF THE INVENTION

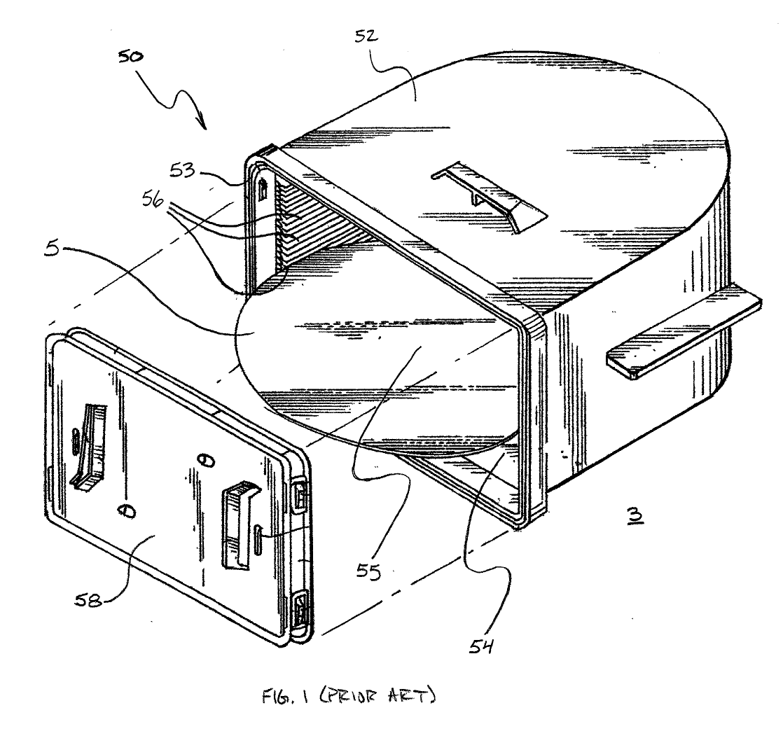

A conventional shipping container 50 for transporting and/or storing semiconductor wafers 5 is shown in FIG. 1. The conventional shipping container 50 includes a housing 52 having a housing wall 53, the housing 52 having an interior cavity 54 for receiving one or more semiconductor wafers 5 (only one shown for clarity). Wafers 5 may be inserted into the interior cavity 54 through an opening 55 thereof. Within the interior cavity 54, a plurality of shelves 56 are disposed on the wall 53 of the housing 52, and each shelf 56 is adapted to receive and support a wafer 5. The shipping container 50 also includes a movable door or cover 58 for covering the opening 55 and enclosing the interior cavity 54. The movable door 58 may be removable, as depicted in FIG. 1, or coupled with the housing 52 by one or more hinges. To transport and/or store a plurality of wafers 5, the wafers 5 may be placed in the interior cavity 54—each wafer being received in one of the shelves 56—and the moveable door 58 secured to the housing 52.

The shipping container 50 illustrated in FIG. 1 is representative of a broad array of conventional shipping containers, and it should be understood that the present invention is not limited to the specific container 50 shown in FIG. 1. Further, it should be understood that the present invention is not limited to containers for shipping semiconductor wafers. For example, the invention may be applicable to shipping containers for transporting and/or storing other sensitive components, such as magnetically or optically accessible disks used in the construction of disk drives and other devices, as well as flat panel displays.

When the movable door 58 is secured to the housing 52 to enclose a plurality of wafers 5 within the interior cavity 54, the interior cavity 54 and its contents are housed in an environment that is generally sealed off and/or protected from the surrounding environment 3. However, certain types of chemicals and/or particulates, as well as moisture, may be able to penetrate the seal provided between the housing 52 and movable door 58 or to otherwise permeate the shipping container 50. Also, conditions in the surrounding environment 3 may impact the environment within the interior cavity 54. By way of example, an elevated temperature in the surrounding environment 3 will typically result in an elevated temperature within the shipping container 50. Similarly, vibration and shock imparted to the exterior of the shipping container 50 will generally be transmitted to the contents resting within the interior cavity 54 of shipping container 50. Further, contaminants may be generated (e.g., by outgassing or by particulate generation due to relative movement between the container 50 and its contents) within the shipping container 50 itself. As noted above, these adverse environmental conditions may damage a semiconductor wafer 5 (or other sensitive component), and an IC manufacturer may have no knowledge that a wafer was subjected to such conditions during transport and/or storage.

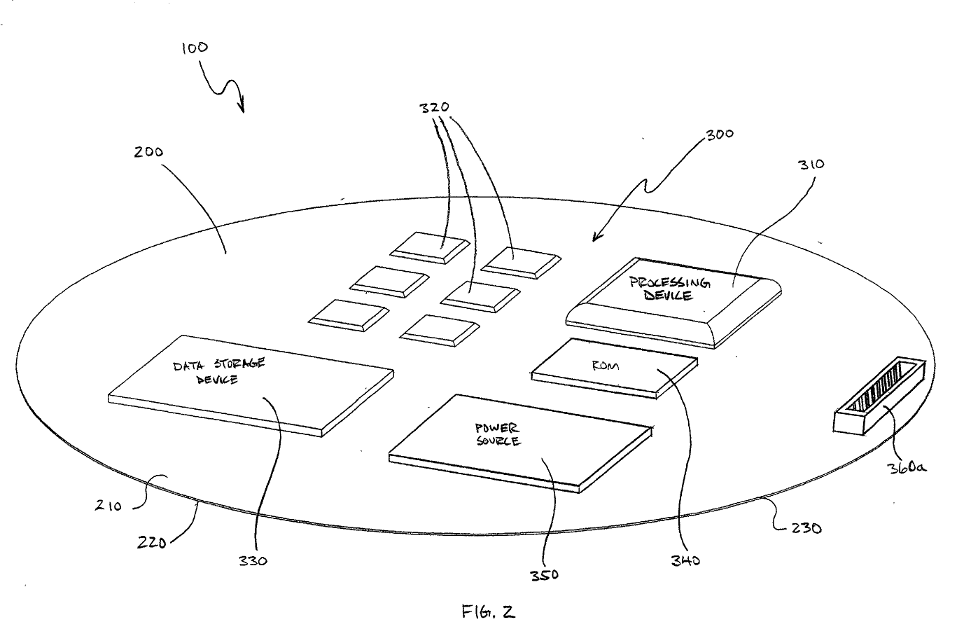

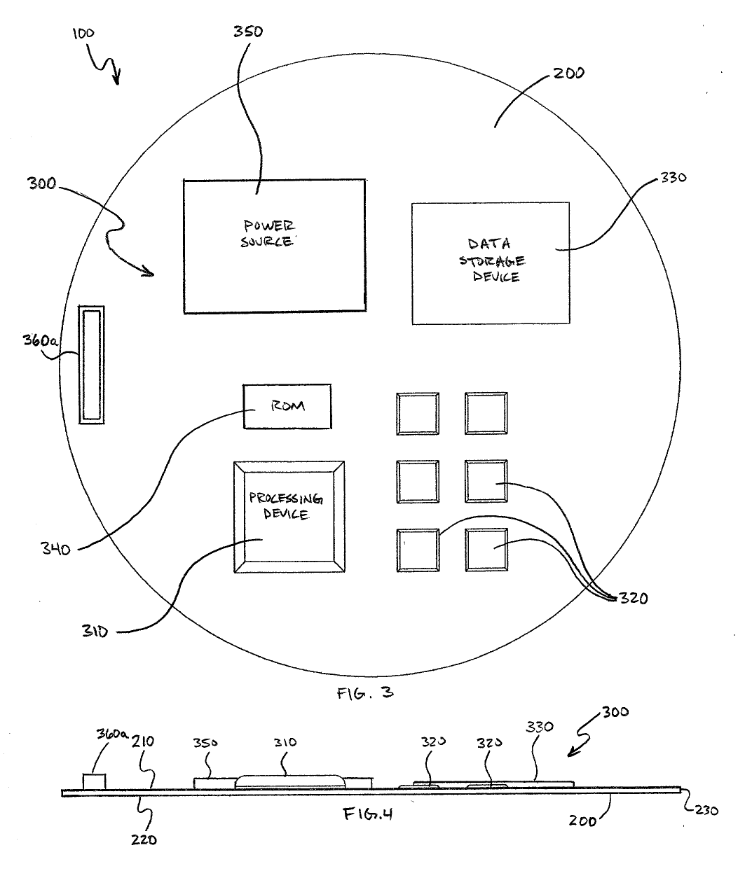

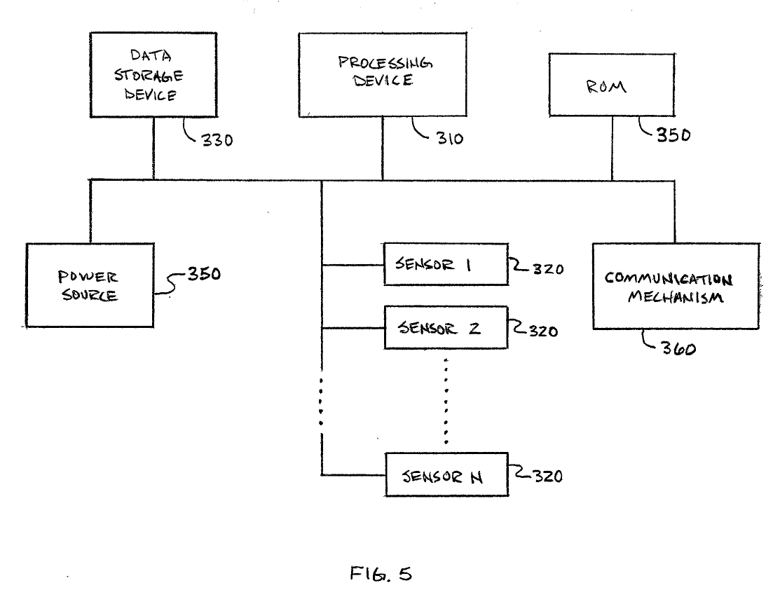

An embodiment of an instrumented substrate 100 is illustrated in FIGS. 2 through 4. The instrumented substrate 100 may be used to record the environmental conditions within any type of shipping container during transport and/or extended storage, as well as to record the environmental conditions within any other type of container for receiving environmentally sensitive components. Also, the instrumented substrate 100 may be used to monitor the environmental conditions for any type of sensitive component—including semiconductor wafers, both raw and processed, as well as magnetically accessible disks, optically accessible disks, and flat panel displays—where knowledge of such conditions may increase production yields, lower costs, and improve product quality. Further, the instrumented substrate may be used to evaluate the design of a shipping container, as well as to evaluate modes and methods of transportation.

Referring to FIGS. 2 through 4, the instrumented substrate 100 includes a substrate 200 and a monitoring system 300. The substrate 200 has an upper surface 210 and an opposing lower surface 220, and the substrate 200 also has a perimeter 230. The substrate 200 may be of any suitable shape and configuration, so long as the substrate 200 can be received within the interior cavity 54 of a shipping container 50. For example, as illustrated in FIGS. 2 through 4, the substrate 200 may comprise a generally planar disk. Such a planar disk may exhibit a size and shape similar to a semiconductor wafer 5 or, alternatively, a size and shape similar to a magnetically or optically accessible disk. The substrate 200 may, however, comprise any other suitable configuration and shape, such as a square shape or other polygonal shape. For example, the substrate 200 may have a configuration and shape similar to a complete or partially fabricated flat panel display. Further, the substrate 200 may include one or more apertures extending through its thickness. By way of example, the substrate 200 may include a plurality of “cutouts” (e.g., to reduce weight), or the substrate 200 may comprise a lattice or honeycomb structure.

The substrate 200 may comprise any suitable material or combination of materials. By way of example, the substrate 200 may be constructed of a semiconductor material, such that the substrate 200 exhibits a behavior (e.g., structurally, electrically, chemically) that is similar to a semiconductor wafer 5, which may be desirable for certain types of measurements (e.g., acceleration). However, other materials—including circuit board materials, plastics, both ferrous and non-ferrous metals, and composites—are believed suitable for substrate 200. In another embodiment, the substrate 200 comprises a sorbent material (e.g., a desiccant material) to absorb undesirable substances (e.g., water moisture), thereby removing such substances from the interior cavity 54 of the shipping container 50 and minimizing contamination of the container's contents.

The monitoring system 300 is disposed on the substrate 200. The monitoring system 300 may be disposed on one of the substrate surfaces 210, 220 (e.g., upper surface 210, as shown in the figures) or, alternatively, the monitoring system 300 may be disposed on both surfaces 210, 220 of the substrate 200. In another embodiment, all or a portion of the monitoring system 300 is disposed within the substrate 200. For example, the substrate 200 may comprise a multi-layered substrate (e.g., a circuit board material), wherein all or a portion of the monitoring system 300 is disposed on, or formed within, the inner layers of the multi-layered substrate. In a further embodiment, all or a portion of the monitoring system 300 is formed directly on the substrate 200. By way of example, the substrate 200 may comprise a semiconductor material, and at least a portion of the monitoring system's circuitry is formed directly on the semiconductor material.

When the instrumented substrate 100 is placed within a closed shipping container 50, the monitoring system 300 measures at least one environmental characteristic within the interior cavity 54 of the shipping container 50. Environmental characteristics that may be monitored include, by way of example only, temperature, humidity, pressure, the presence of a chemical, the presence of particulates, electromagnetic radiation, electrical charge on the substrate 200 and/or shipping container 50, and acceleration of the substrate 200 and/or shipping container 50. Further, the monitoring system 300 stores data indicative of any measured environmental characteristics, such that the measured characteristics may be indicated to a user or otherwise downloaded from the monitoring system 300 for analysis.

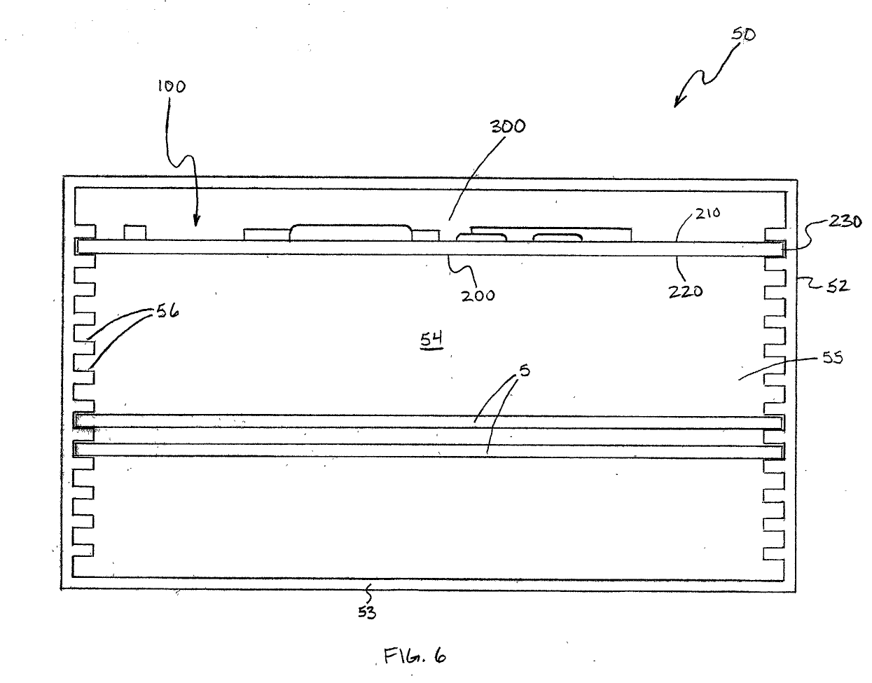

Referring to FIGS. 2 through 4 in conjunction with FIG. 5, which illustrates a schematic diagram of one embodiment of the monitoring system 300, the monitoring system 300 includes a processing device 310. The processing device 310 may comprise any suitable processor, application specific integrated circuit (ASIC), programmable logic device (PLD), or other circuitry. As will be explained below, the processing device 310 controls operation of the monitoring system 300 and may perform data acquisition, post processing, as well as other functions.

The monitoring system 300 also includes one or more sensors 320 coupled with the processing device 310. A sensor 320 may comprise a temperature sensor, a humidity sensor, a pressure sensor, a sensor to detect the presence of a chemical or chemicals, a sensor to detect the presence of particulates, an electromagnetic radiation sensor, or an acceleration sensor (for measuring vibration and/or shock), as well as any other suitable sensor, as desired. During operation, each of the sensors 320 outputs an electrical signal (e.g., a voltage) representative of the environmental parameter being detected, and each sensor 320 may provide that electrical signal to the processing device 310.

The monitoring system 300 further includes a data storage device 330 coupled with the processing device 310. The data storage device 330 stores data representative of the characteristics measured by sensors 320. The data storage device 330 may comprise any suitable memory, including RAM (random access memory), flash memory, a miniature disk drive, or other memory device. In another embodiment, the data storage device 330 includes a removable memory device (e.g., a removable flash memory card). During operation, the processing device 310 will receive electrical signals from the sensors 320, as noted above, and will store data representative of those electrical signals in the data storage device 330. Optionally, as will be explained below, the processing device 310 may store unprocessed electrical signals in the data storage device 330.

The processing device 310 controls operation of the monitoring system 300, as noted above. Exemplary functions performed by the processing device 310 include data acquisition and post processing. The processing device 310 may poll the sensors 320 to determine their respective states (e.g., a voltage or current level). The processing device 310 may poll a sensor 320 periodically or, alternatively, the processing device 310 may poll a sensor 320 in a non-periodic manner. Alternatively, rather than being polled by the processing device 310, a sensor 320 may output an electrical signal to the processing device at regular intervals.

Typically, a sensor 320 will provide an electrical signal that is indicative of the particular environmental phenomenon being measured, and the processing device 310 may perform post-processing to convert the electrical signal to a value indicative of the measured characteristic (e.g., temperature). The processing device 310 may then store the converted value—or, optionally, the unprocessed electrical signal (e.g., a voltage or current)—in the data storage device 330. The processing device 310 may act under control of a set of instructions stored in a ROM (read-only memory) 340, the ROM memory 340 being coupled with the processing device 310.

The monitoring system 300 may also include an on-board power source 350, as shown in FIGS. 2 through 4. The on-board power source 350 may comprise, for example, a battery. Alternatively, as will be explained below, the monitoring system 300 may utilize an external power source. The on-board power source 350 provides power to (and is coupled with) each of the processing device 310, sensors 320, data storage device 330, and ROM memory 340, as well as other components of the monitoring system 300.

The monitoring system 300 may further include a communication mechanism 360. In one embodiment, as shown in FIGS. 2 through 4, the communication mechanism simply comprises a connector 360a that is coupled with the processing device 310. The connector 360a enables the monitoring system 300 to be coupled via a hard-wire connection with an external device (e.g., a computer system), such that any data stored in data storage device 330 may be downloaded to the external device for subsequent analysis and/or processing. In another embodiment, which will be explained below, the communication mechanism 360 comprises a wireless communication device.

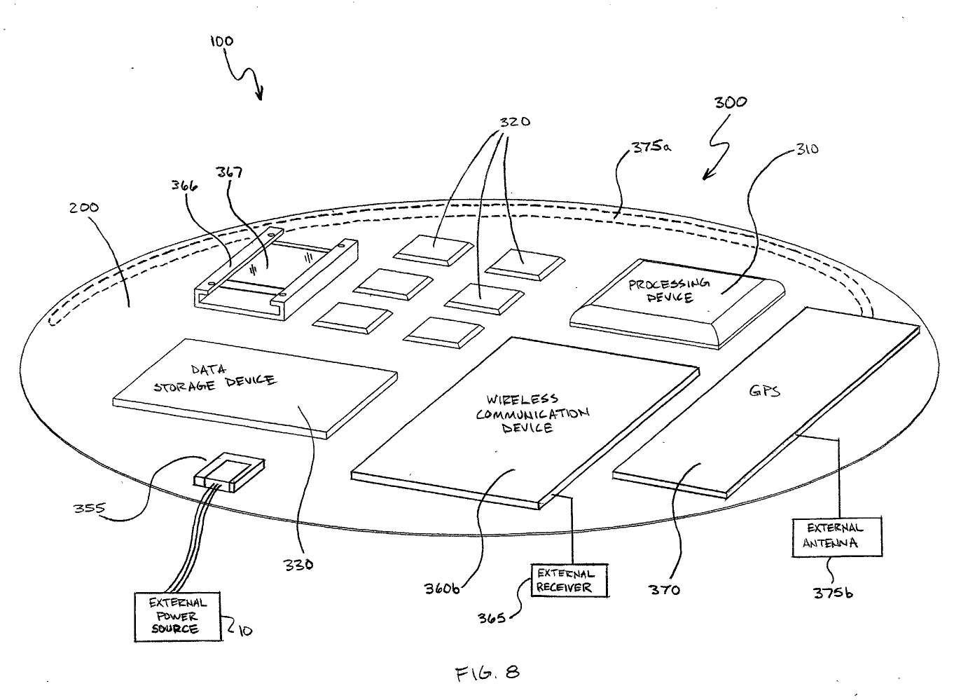

It should be understood that the monitoring system 300 may include other elements—which have been omitted for clarity and ease of understanding—in addition to those shown and described with respect to FIGS. 2 through 5. For example, the monitoring system 300 may include additional circuitry to perform signal conditioning (e.g., for sensors 320), to perform filtering, and/or to perform addressing (e.g., a memory controller). It should be understood, however, that any of these functions may be performed in the processing device 310. The monitoring system 300 may also include a plurality of signal lines and buses—which have been omitted from FIGS. 2 through 4, as well as from FIGS. 7 through 9, for clarity—interconnecting the various elements of the monitoring system 300.

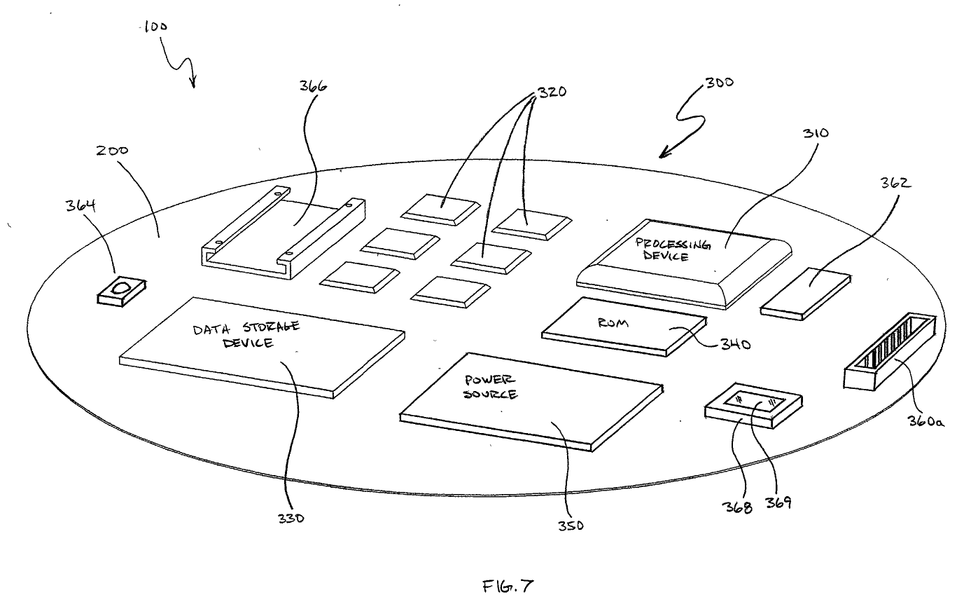

The instrumented substrate 100 may be placed in a shipping container 50, as shown in FIG. 6, to monitor the environmental conditions within the container during transportation and/or storage. The instrumented substrate 100 is inserted into one of the shelves 56 provided in the interior cavity 54 of the shipping container 50, the lower surface 220 of the substrate 200 supported proximate the perimeter 230 thereof by the shelf (or shelves) 56 that extend about at least a portion of the perimeter 230 of the substrate 200. Although shown in the uppermost shelf 56 of the shipping container 50 which may provide more clearance for the instrumented substrate 100 than lower slots it should be understood that the instrumented substrate 100 may be positioned in any one of the shelves 56 of the shipping container 50. One or more wafers 5 may also be disposed within the shipping container 50, each wafer 5 received in one of the shelves 56. The movable door or cover 58 is secured to the housing 52 to enclose the interior cavity 54 and the contents placed therein. The instrumented substrate 100 may then measure environmental characteristics within the shipping container 50 during transportation and/or storage.

Alternative embodiments of the instrumented substrate 100 are illustrated in FIG. 7. In one embodiment, the monitoring system 300 includes clock circuitry 362, the clock circuitry 362 being coupled with the processing device 310. During operation, it may be desirable to log various environmental conditions as a function of time, wherein both the measured characteristic and the corresponding time value are stored in the data storage device 330. The clock circuitry 362 provides an indication of time to the processing device 310.

In another embodiment, as shown in FIG. 7, the monitoring system 300 of instrumented substrate 100 includes one or more threshold indicators 364. In addition to logging various environmental conditions for subsequent downloading and analysis—or in lieu thereof—it may be desirable to simply provide an indication if a specified characteristic has exceeded a predefined threshold. For example, rather than logging temperature measurements throughout the duration of transportation or storage, a threshold indicator 364 can indicate if the temperature within a shipping container 50 has exceeded a specified threshold temperature. If the temperature has exceeded the specified threshold, thereby triggering the threshold indicator 364, the contents of the shipping container 50 were subjected to a peak temperature that exceeded the threshold and, further, that may have caused damage to the contents of the shipping container 50. If the threshold indicator 364 has not been triggered, no adverse temperature conditions existed during transportation and/or storage.

The threshold indicator 364 may comprise any suitable device capable of providing an indication to a user that an environmental parameter has exceeded a specified threshold for that parameter. For example, the threshold indicator 364 may comprise an LED (light emitting diode) or other device—e.g., a display device, as will be described below—providing a visual indication that the threshold indicator 364 has been triggered due to an environmental parameter exceeding its predefined threshold. Alternatively, if an environmental condition has exceeded a predefined threshold, the processing device 310 may store data in the data storage device 330 indicating that the environmental condition exceeded the threshold.

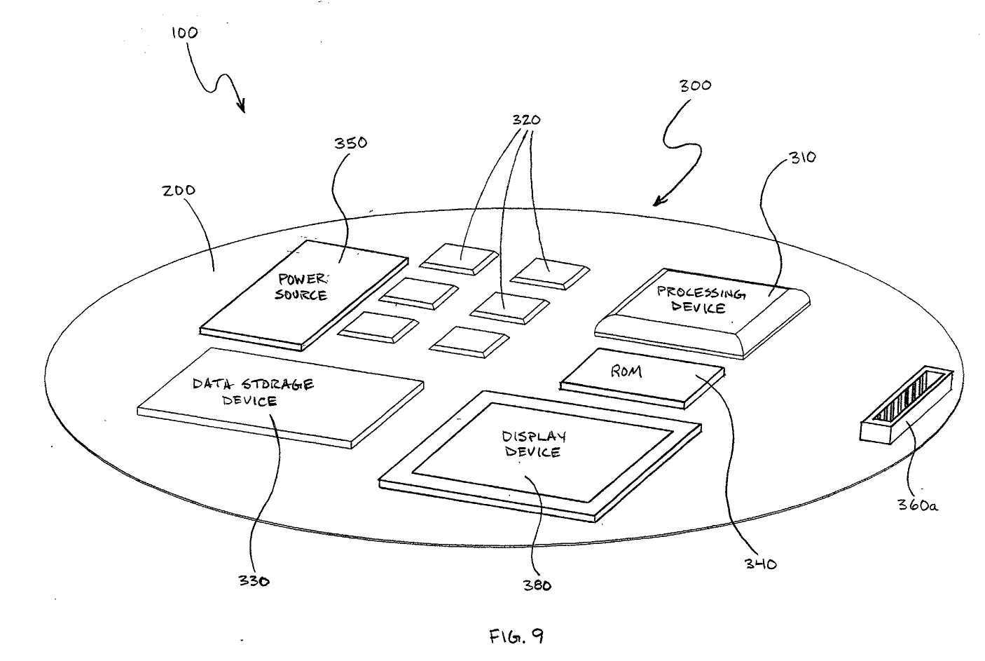

In a further embodiment shown in FIG. 7, the monitoring system 300 of instrumented substrate 100 includes a coupon holder 366. A test coupon (see FIG. 8, reference numeral 367) may be inserted into and retained by the coupon holder 366. Such a test coupon may comprise a material sample that is similar or identical to a material being transported and/or stored within a shipping container 50. For example, if the contents of a shipping container 50 include a plurality of semiconductor wafers 5, the test coupon may comprise a similar semiconductor material. After transportation and/or storage, the test coupon may be removed from the coupon holder 366 and subjected to further testing, including destructive testing. Use of a coupon holder 366 and a test coupon allows for the testing and analysis of an actual material sample without the need to sacrifice product.

In yet another embodiment, as illustrated in FIG. 7, the monitoring system 300 of instrumented substrate 100 includes an air sampler 368. The air sampler 368 will collect a sample of the air (or, more generally, the atmosphere) within the interior cavity 54 of a shipping container 50 during transportation and/or storage. After transportation and/or storage, the air sample collected by the air sampler 368 can be analyzed for any adverse environmental characteristics (e.g., chemicals, moisture, particulates). The air sampler 368 may comprise any suitable device capable of collecting and retaining an air sample. For example, the air sampler 368 may include a sorbent material 369 that may absorb a volume of air for later analysis. It should be understood, however, that the monitoring system 300 may include a number of sensors 320 that measure a variety of characteristics of the air within the interior cavity 54 of a shipping container 50.

Additional embodiments of the instrumented substrate 100 are illustrated in FIG. 8. Referring to FIG. 8, in lieu of an on-board power source 350—as shown and described in FIGS. 2 through 4—the monitoring system 300 of instrumented substrate 100 may include a power connector 355 for coupling the monitoring system 300 with an external power source 10. In an alternative embodiment, the monitoring system 300 may include an on-board power source 350 in combination with a power connector 355 for coupling with an external power source 10. In this embodiment, the on-board power source 350 may serve as a back-up if the external power source 10 fails or is inadvertently disconnected from the power connector 355. In yet another embodiment, the power connector 355 and the connector 360a comprise a single, integrated connector.

In a further embodiment illustrated in FIG. 8, rather than a connector 360a for communications, the communication mechanism 360 comprises a wireless communication device 360b. The wireless communication device 360b may include any suitable wireless communication technology and/or method. For example, the wireless communication device 360b may comprise an RF (radio frequency) or microwave communication system, an IR (infrared) communication system, a satellite communication system, or a cellular telephony communication system. An external receiver 365 may be coupled with the wireless communication device 360b. The external receiver 365 may comprise an IR receiver for receiving infrared signals or an antenna for receiving RF, microwave, satellite, or cellular communication signals. Use of a wireless communication device 360b allows data to be downloaded from the monitoring system 300 during transportation and/or storage. Data may be downloaded in real time, at periodic intervals, or simply upon request of the user. A wireless communication device 360b may also be used to download data after transit or storage.

In yet another embodiment, as shown in FIG. 8, the monitoring system 300 of instrumented substrate 100 includes a Global Positioning System (GPS) receiver 370. The Global Positioning System is a collection of satellites orbiting above the Earth which transmit signals that can be detected using an appropriately configured receiver—i.e., a GPS receiver. If the signals from an adequate number of satellites are detected, these GPS signals can be used to determine the location of the GPS receiver. The GPS receiver 370 may comprise any suitable GPS receiver known in the art and, further, the GPS receiver 370 may be adapted to receive Differential GPS (DGPS) correction information. Differential GPS systems, such as the Wide Area Augmentation System (WAAS) and the Local Area Augmentation System (LAAS), provide error compensation and improve GPS position determinations using one or more GPS receivers fixed at known locations.

The GPS receiver 370 is coupled with an antenna for receiving GPS signals and, optionally, DGPS correction data. For example, the GPS receiver 370 may be coupled with an on-board antenna 375a. The on-board antenna 375a is disposed on the substrate 200 and may be formed directly on, or within, the substrate 200. Alternatively, the GPS receiver 370 may be coupled with an external antenna 375b. It will be appreciated that the wireless communication device 360b and the GPS receiver 370 may share a single, integrated antenna, such a shared antenna comprising either an on-board antenna or an external antenna.

In order to obtain an accurate geographical reference point based upon a plurality of GPS signals, it is necessary to have an accurate time reference. To meet this need, each GPS satellite is adapted to provide a highly accurate and precise time basis, this time basis being transmitted with the GPS signal originating from a GPS satellite. One or more GPS signals received by the GPS receiver 370 can, therefore, provide a very accurate time reference. Thus, the GPS receiver 370 can provide the processing device 310 with an accurate source of time, thereby enabling environmental characteristics to be recorded as a function of time, and additional clock circuitry 362 (see FIG. 7) may be unnecessary.

Using the GPS receiver 370, environmental conditions within a shipping container 50 may be recorded as a function of geographic location of the shipping container 50 during transit and/or storage. When semiconductor wafers and/or other environmentally sensitive components are transported along a common route (whether by land, sea, air, or a combination thereof), knowledge of changes in environmental conditions as a function of geographic location will allow for the identification of locations along the route where adverse environmental conditions are consistently encountered. Thus, new routes and/or improved modes of transportation may be selected to avoid the identified geographic locations and/or to alleviate the affects of the adverse environmental conditions. Also, the GPS receiver 370 may be used to facilitate inventory control and tracking. Further, because the GPS receiver 370 can provide an accurate time reference, environmental conditions can be monitored as a function of both time and geographic location.

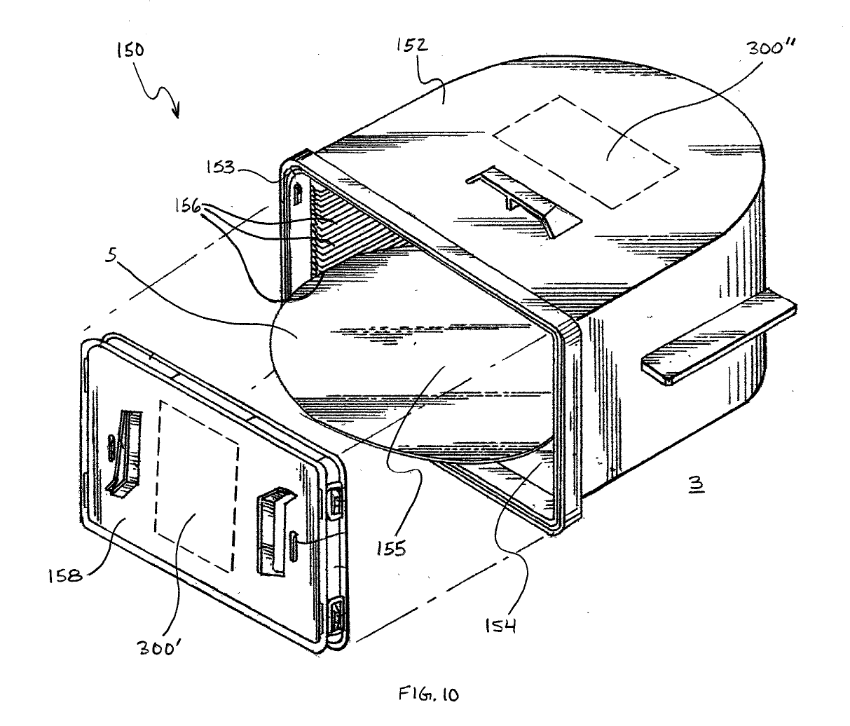

In yet a further embodiment of the instrumented substrate 100, as shown in FIG. 9, the monitoring system 300 includes a display device 380. The display device 380 may comprise any suitable visual display system, including, for example, an LCD (liquid crystal display) or similar device. Measured environmental parameters may be displayed directly to an operator on the display device 380. The display device 380, in conjunction with one or more command entry devices (e.g., switches, push-buttons), may be used by an operator for command entry and/or programming. It should be understood, however, that command entry and programming may be achieved using other methods or devices, such as, for example, via wireless communication device 360b. The display device 380 may also function as a threshold indicator, as described above. The display device 380 may be provided in lieu of a communications mechanism 360 or, alternatively, the display device 380 may be provided in combination with either a connector 360a (as shown in FIG. 9) or a wireless communication device 360b.

The various components that may comprise the monitoring system 300—e.g., processing device 310, sensors 320, data storage device 330, ROM memory 340, power source 350, communication mechanism 360a-b, clock circuitry 362, threshold indicator 364, air sampler 368, GPS receiver 370, and display device 380—may comprise separate parts that are secured to the substrate 200 and interconnected. Alternatively, one or more of these monitoring system components may be formed directly on or within the substrate 200, as noted above.

Although illustrated as separate components, two or more of the monitoring system's components may share circuitry or comprise a single integrated component. For example, a wireless communication device 360b and a GPS receiver 370 may share processing circuitry or, alternatively, the processing device 310 may provide processing capabilities for each of the wireless communication device 360b and the GPS receiver 370. The clock circuitry 362 and the processing device 310 may comprise a single integrated component and, similarly, the data storage device 330 and ROM memory 340 may comprise an integrated memory device.

The various components—e.g., processing device 310, sensors 320, data storage device 330, ROM memory 340, power source 350, communication mechanism 360a-b, clock circuitry 362, threshold indicator 364, coupon holder 366, air sampler 368, GPS receiver 370, and display device 380—shown and described with respect to FIGS. 2 through 9 are intended to represent a broad array of each such device, respectively. It should be understood, however, that the illustrated components do not necessarily represent the actual size, shape, or configuration of any actual device. Rather, the components shown in FIGS. 2 through 9 are intended to represent exemplary components and are presented simply for illustrative purposes.

In FIGS. 2 through 9, the instrumented substrate 100 includes a monitoring system 300 that is disposed on a substrate 200, the instrumented substrate 100 having a size and configuration suitable for insertion into an interior cavity 54 of a shipping container 50. Referring now to FIG. 10, a monitoring system may be disposed directly on a shipping container to form an instrumented container 150. The configuration of the instrumented container 150 shown in FIG. 10 is only exemplary, and it should be understood that a monitoring system according to the present invention may be disposed in any type or configuration of shipping container or other container.

The instrumented container 150 includes a housing 152 having a housing wall 153, the housing 152 having an interior cavity 154 for receiving one or more semiconductor wafers 5 (only one shown for clarity) or other environmentally sensitive components. Wafers 5 may be inserted into the interior cavity 154 through an opening 155 thereof. Within the interior cavity 154, a plurality of shelves 156 are disposed on the wall 153 of the housing 152, and each shelf 156 is adapted to receive and support a wafer 5. The instrumented container 150 also includes a movable door or cover 158 for covering the opening 155 and enclosing the interior cavity 154. The movable door 158 may be removable, as depicted in FIG. 10, or coupled with the housing 152 by one or more hinges. To transport and/or store a plurality of wafers 5, the wafers 5 may be placed in the interior cavity 154—each wafer being received in one of the shelves 156—and the moveable door 158 secured to the housing 152.

The instrumented container 150 also includes a monitory system for recording at least one environmental characteristic within the interior cavity 154 thereof. A monitoring system 300′ may be disposed on and/or within the movable door or cover 158 or, alternatively, a monitoring system 300″ may be disposed on and/or within the wall 153 of the housing 152. The monitoring system 300′, 300″ may be permanently mounted on the instrumented container 150 or, alternatively, the monitoring system 300′, 300″, or a portion thereof, may be removable. The monitoring system 300′, 300″ of instrumented container 150 would function in a manner similar to the monitoring system 300 of instrumented substrate 100 shown and described above with respect to FIGS. 2 through 9.

It should be understood that, although the embodiments of an instrumented substrate 100 and an instrumented container 150 have been described above in the context of transporting sensitive components between facilities or storing such components for extended periods of time outside the fabrication environment, the present invention is applicable to the transportation of components within a manufacturing facility. For example, the instrumented substrate 100 may be used in a processing container for transporting components between processing stations within the same manufacturing facility or, alternatively, a monitoring system 300 may be disposed on such a processing container to form an instrumented processing container. Sensing and recording the environmental conditions that components are subjected to within a manufacturing facility may be desirable where controlled environments are maintained at various locations (e.g., processing stations) within the manufacturing facility, but are not maintained at intermediate locations.

Embodiments of an instrumented substrate 100, as well as an instrumented container 150, having been herein described, those of ordinary skill in the art will appreciate the advantages thereof. The instrumented substrate 100 may be placed in any type of container (e.g., shipping, processing, etc.) to record one or more environmental conditions within the container during transportation and/or extended storage. Data representative of the measured environmental characteristics may be downloaded in real time via a wireless communication device or, alternatively, downloaded and analyzed after transit. Environmental conditions may be monitored as a function of time and/or geographical location. Recorded environmental data can be used to identify semiconductor wafers that may exhibit a low production yield, thereby insuring quality, increasing production yields, and lowering costs. The recorded environmental data can also be used to evaluate the design of a container, as well as to evaluate modes and methods of transportation.

The foregoing detailed description and accompanying drawings are only illustrative and not restrictive. They have been provided primarily for a clear and comprehensive understanding of the present invention and no unnecessary limitations are to be understood therefrom. Numerous additions, deletions, and modifications to the embodiments described herein, as well as alternative arrangements, may be devised by those skilled in the art without departing from the spirit of the present invention and the scope of the appended claims.

What is claimed is:

1. An instrumented substrate for use with a container, the container having an interior cavity to receive a plurality of components, the instrumented substrate comprising:
a substrate to insert into the interior cavity of the container; and
a monitoring system disposed on the substrate, the monitoring system to sense at least one environmental characteristic.

2. The instrumented substrate of claim 1, the monitoring system to store data corresponding to the at least one environmental characteristic.

3. The instrumented substrate of claim 1, the monitoring system to output data corresponding to the at least one environmental characteristic.

4. The instrumented substrate of claim 1, the substrate having a size and shape substantially similar to each of the plurality of components.

5. The instrumented substrate of claim 4, the substrate having a size and shape substantially similar to a semiconductor wafer.

6. An apparatus comprising:
a substrate to insert into an interior cavity of a container;
a processing device disposed on the substrate;
a sensor disposed on the substrate and coupled with the processing device, the sensor to sense an environmental characteristic; and
a data storage device disposed on the substrate and coupled with the processing device.

7. The apparatus of claim 6, wherein the interior cavity of the container includes a plurality of shelves, the substrate having a size and shape suitable for insertion into one of the plurality of shelves.

8. The apparatus of claim 7, the size and shape of the substrate suitable for insertion into an uppermost one of the plurality of shelves.

9. The apparatus of claim 6, wherein the interior cavity receives generally cylindrical wafers of a specified diameter, the substrate having a generally cylindrical shape of a diameter substantially equivalent to the specified diameter.

10. The apparatus of claim 6, the substrate comprising a semiconductor material.

11. The apparatus of claim 6, the substrate comprising a sorbent material.

12. The apparatus of claim 11, the substrate comprising a desiccant material.

13. The apparatus of claim 6, the sensor comprising one of temperature sensor, a humidity sensor, a pressure sensor, an acceleration sensor, an electromagnetic radiation sensor, an electrical charge sensor, a chemical sensor, and a particle sensor.

14. The apparatus of claim 6, the data storage device comprising one of a RAM memory, a flash memory, and a disk drive.

15. The apparatus of claim 6, further comprising a ROM memory coupled with the processing device.

16. The apparatus of claim 6, further comprising a power source disposed on the substrate and coupled with the processing device, the sensor, and the data storage device.

17. The apparatus of claim 6, further comprising a power connector disposed on the substrate and coupled with the processing device, the sensor, and the data storage device, the power connector connectable with an external power source.

18. The apparatus of claim 6, further comprising a communication mechanism disposed on the substrate and coupled with the processing device.

19. The apparatus of claim 18, the communication mechanism comprising a connector.

20. The apparatus of claim 18, the communication mechanism comprising a wireless communication device.

21. The apparatus of claim 20, the wireless communication device comprising one of an RF communication device, a microwave communication device, a satellite communication device, an IR communication device, and a cellular communication device.

22. The apparatus of claim 6, further comprising a coupon holder disposed on the substrate.

23. The apparatus of claim 6, further comprising clock circuitry disposed on the substrate and coupled with the processing device.

24. The apparatus of claim 6, further comprising an air sampler disposed on the substrate.

25. The apparatus of claim 24, the air sampler including a sorbent material.

26. The apparatus of claim 6, further comprising a threshold indicator coupled with the processing device.

27. The apparatus of claim 26, the threshold indicator comprising a visual indicator.

28. The apparatus of claim 6, further comprising a GPS receiver disposed on the substrate and coupled with the processing device.

29. The apparatus of claim 28, further comprising an on-board antenna coupled with the GPS receiver.

30. The apparatus of claim 29, further comprising a wireless communication device disposed on the substrate and coupled with the processing device and further coupled with the on-board antenna.

31. The apparatus of claim 28, further comprising an external antenna coupled with the GPS receiver.

32. The apparatus of claim 31, further comprising a wireless communication device disposed on the substrate and coupled with the processing device and further coupled with the external antenna.

33. The apparatus of claim 28, the GPS receiver to provide an indication of time.

34. A container comprising:
a housing including a housing wall defining an interior cavity, the housing wall having an opening;
a plurality of shelves disposed on the housing wall within the interior cavity, each shelf of the plurality of shelves to receive a component;
a door movably secured to the housing proximate the opening; and
a monitoring system disposed on one of the housing wall and the door, the monitoring system to sense at least one environmental characteristic within the interior cavity.

35. The container of claim 34, the monitoring system to store data corresponding to the at least one environmental characteristic.

36. The container of claim 34, the monitoring system to output data corresponding to the at least one environmental characteristic.

37. The container of claim 34, said each shelf of the plurality of shelves to receive one of a semiconductor wafer, a magnetically accessible disk, and an optically accessible disk.

38. The container of claim 34, wherein at least a portion of the monitoring system is removable.

39. A container, comprising:
a housing including a housing wall defining an interior cavity, the housing wall having an opening;
a door movably secured to the housing proximate the opening; and
a monitoring system disposed on one of the housing wall and the door, the monitoring system including
a processing device,
a sensor coupled with the processing device, the sensor to sense an environmental characteristic, and
a data storage device coupled with the processing device.

40. The container of claim 39, wherein the interior cavity includes a plurality of shelves, each of the plurality of shelves to receive a component.

41. The container of claim 40, each of the plurality of shelves to receive a semiconductor wafer.

42. The container of claim 34, the sensor comprising one of temperature sensor, a humidity sensor, a pressure sensor, an acceleration sensor, an electromagnetic radiation sensor, an electrical charge sensor, a chemical sensor, and a particle sensor.

43. The container of claim 39, the data storage device comprising one of a RAM memory, a flash memory, and a disk drive.

44. The container of claim 39, the monitoring system further comprising a ROM memory coupled with the processing device.

45. The container of claim 39, the monitoring system further comprising a power source coupled with the processing device, the sensor, and the data storage device.

46. The container of claim 39, the monitoring system further comprising a power connector coupled with the processing device, the sensor, and the data storage device, the power connector connectable with an external power source.

47. The container of claim 39, the monitoring system further comprising a communication mechanism coupled with the processing device.

48. The container of claim 47, the communication mechanism comprising a connector.

49. The container of claim 47, the communication mechanism comprising a wireless communication device.

50. The container of claim 49, the wireless communication device comprising one of an RF communication device, a microwave communication device, a satellite communication device, an IR communication device, and a cellular communication device.

51. The container of claim 39, the monitoring system further comprising a coupon holder.

52. The container of claim 39, the monitoring system further comprising clock circuitry coupled with the processing device.

53. The container of claim 39, the monitoring system further comprising an air sampler.

54. The container of claim 53, the air sampler including a sorbent material.

55. The container of claim 39, the monitoring system further comprising a threshold indicator coupled with the processing device.

56. The container of claim 55, the threshold indicator comprising a visual indicator.

57. The container of claim 39, the monitoring system further comprising a GPS receiver coupled with the processing device.

58. The container of claim 57, the monitoring system further comprising an on-board antenna coupled with the GPS receiver.

59. The container of claim 58, the monitoring system further comprising a wireless communication device coupled with the processing device and further coupled with the on-board antenna.

60. The container of claim 57, the monitoring system further comprising an external antenna coupled with the GPS receiver.

61. The container of claim 60, the monitoring system further comprising a wireless communication device coupled with the processing device and further coupled with the external antenna.

62. The container of claim 57, the GPS receiver to provide an indication of time.

63. A method comprising:
disposing an instrumented substrate within the interior cavity of a container;
sensing an environmental characteristic with the instrumented substrate; and
storing data on the instrumented substrate, the data corresponding to the environmental characteristic.

64. The method of claim 63, further comprising sensing the environmental characteristic as a function of time.

65. The method of claim 63, further comprising sensing the environmental characteristic as a function of geographic location of the container.

66. The method of claim 63, further comprising sensing the environmental characteristic as a function of time and geographic location of the container.

67. The method of claim 63, the act of sensing an environmental characteristic comprising one of sensing temperature, sensing humidity, sensing pressure, sensing acceleration, sensing electromagnetic radiation, sensing electrical charge, sensing a chemical, and sensing particles.

68. The method of claim 63, further comprising downloading the data from the instrumented substrate to an external system.

69. The method of claim 68, further comprising downloading the data to the external system via a wireless connection.

70. The method of claim 68, further comprising downloading the data to the external system in real time.

71. The method of claim 63, further comprising placing a test coupon on the instrumented substrate.

72. The method of claim 63, further comprising collecting an air sample within the interior cavity.

73. The method of claim 63, further comprising indicating that the environmental characteristic has exceeded a predefined threshold.

74. The method of claim 73, further comprising visually indicating that the environmental characteristic has exceeded the predefined threshold.

75. The method of claim 63, further comprising:
storing the data in a removable memory device on the instrumented substrate; and
removing the removable memory device from the instrumented substrate.

76. The method of claim 75, the act of storing the data in a removable memory device comprising storing the data in a flash memory device.

77. A method comprising:
providing a container including a housing wall defining and interior cavity having an opening, the container further including a door movably secured to the housing proximate the opening;
providing a monitoring system disposed on one of the housing wall and the door;
sensing an environmental characteristic within the interior cavity with the monitoring system; and
storing data in the monitoring system, the data corresponding to the environmental characteristic.

78. The method of claim 77, further comprising inserting a component within the interior cavity of the container, the component received in one of a plurality of shelves disposed on the housing wall.

79. The method of claim 78, wherein the component comprises one of a semiconductor wafer, a magnetically accessible disk, an optically accessible disk, and a flat panel display.

80. The method of claim 77, further comprising sensing the environmental characteristic as a function of time.

81. The method of claim 77, further comprising sensing the environmental characteristic as a function of geographic location of the container.

82. The method of claim 77, further comprising sensing the environmental characteristic as a function of time and geographic location of the container.

83. The method of claim 77, the act of sensing an environmental characteristic comprising one of sensing temperature, sensing humidity, sensing pressure, sensing acceleration, sensing electromagnetic radiation, sensing electrical charge, sensing a chemical, and sensing particles.

84. The method of claim 77, further comprising downloading the data from the monitoring system to an external system.

85. The method of claim 84, further comprising downloading the data to the external system via a wireless connection.

86. The method of claim 84, further comprising downloading the data to the external system in real time.

87. The method of claim 77, further comprising collecting an air sample within the interior cavity.

88. The method of claim 77, further comprising indicating that the environmental characteristic has exceeded a predefined threshold.

89. The method of claim 88, further comprising visually indicating that the environmental characteristic has exceeded the predefined threshold.

90. The method of claim 77, further comprising:
storing the data in a removable memory device; and
removing the removable memory device from the monitoring system.

91. The method of claim 90, the act of storing the data in a removable memory device comprising storing the data in a flash memory device.
